(19) United States
(12) Patent Application Publication
(10) Pub. No.: US 2010/0088844 A1
(43) Pub. Date: Apr. 15, 2010

(54) APPARATUS FOR CLEANING CYLINDRICAL AIR FILTERS

(76) Inventors: Stuart Cole, New South Wales (AU); Gordon Scott, New South Wales (AU)

Correspondence Address: GREER, BURNS & CRAIN, 300 S WACKER DR, 25TH FLOOR, CHICAGO, IL, 60606, US

(21) Appl. No.: 12/438,447

(22) PCT Filed: Aug. 20, 2007
(86) PCT No.: PCT/AU07/01183

§ 371 Date: Oct. 19, 2009

(30) Foreign Application Priority Data
Aug. 21, 2006 (AU) 2006904742
Apr. 5, 2007 (AU) 2007901828

(51) Int. Cl. B05B 15/12

(52) U.S. Cl. 15/405

(57) ABSTRACT

An apparatus for removing particulates from a cylindrical air filter includes: a rotating device for rotating the air filter about a longitudinal axis; and a cleaning device including a nozzle adapted to blow a gas through the air filter to remove particulates from the air filter, wherein the rotating device and the cleaning device are mounted for relative movement whereby the nozzle traverses longitudinally through the rotating air filter, and wherein the air filter is both mounted to the apparatus and cleaned in a substantially horizontal orientation.

### FIELD OF THE INVENTION

The present invention relates to an apparatus for cleaning air filters. In particular, the present invention relates to removing particulates from air filters.

### BACKGROUND ART

Air filters have long been used in applications where air quality is important, such as within air intake systems for internal combustion engines.

The role of air filters in vehicular applications is to prevent abrasive particulate matter from entering the cylinders of the engine, causing oil contamination and mechanical wear. These air filters may be in a number of forms, the most common being either cylindrical or in the form of a flat, rectangular (often pleated) panel. Cylindrical air filters are used particularly in heavy machinery in, for instance, agricultural, mining and industrial applications. The majority of cylindrical air filters use pleated paper as the filter media, although foam and cotton may also be used.

Over time, cylindrical air filters will begin to work less effectively as particulate matter begins to clog the filter. As a result, the engine may draw in less air, potentially resulting in a decrease in vehicle performance. In addition, a clogged filter is more likely to undergo a catastrophic failure, resulting in contamination of the air intake with damaging particulates. The time taken for a filter to become clogged varies on the conditions under which the vehicle is used. However, in dusty conditions, such as on mine and construction sites as well as on farms, air filters will rapidly become clogged with particulates. As a result, regular replacement or maintenance of the filter is required.

Whilst many air filter manufacturers do not recommend cleaning filters due to the risk of damage to the integrity of the filter media, in practice air filters are often cleaned in order to minimise the cost of replacement filters. Air filters may be cleaned by, for instance, hitting the filter against another object to shake lightly entrapped dust loose from the filter, or by cleaning the air filter using compressed air or similar gas to blow more heavily entrapped particles from the filter. In using a compressed gas to clean an air filter an operator manually positions a nozzle adjacent the interior surface of the filter media to blow any particulate matter out of the media. Using compressed gases may rupture the filter media if too high a pressure is used or the nozzle is placed too close to, or contacts, the filter media. This is a particular problem with cylindrical filters, where access for an operator to carefully position the nozzle within the cylindrical filter is often quite restricted. This process is also slow, labor-intensive and inefficient.

Additionally, the dust generated when manually cleaning a cylindrical air filter may pose a health and safety hazard. When a compressed gas is used to blow particulate matter out of the filter media, the particulates become airborne. Thus, the operator cleaning the air filter, as well as any other person in the vicinity must wear a dust mask or respirator as well as eye protection. Furthermore, if the cleaning is performed indoors without adequate dust extraction facilities, then other surfaces and equipment will become coated in a layer of particulate matter as it settles. On the other hand, if the cleaning is performed outdoors, there is the potential that the particulate matter blown out of the filter media may have an adverse impact on the surrounding environment.

### SUMMARY OF THE INVENTION

We have now found an apparatus for removing particulates from cylindrical air filters which may overcome at least some of the abovementioned disadvantages, or provide a useful or commercial choice. In one form, the present invention resides in an apparatus for removing particulates from a cylindrical air filter, said apparatus comprising a rotating means for rotating the air filter about a longitudinal axis, and a cleaning means comprising a nozzle adapted to blow a gas through said air filter to remove particulates from the air filter, wherein the rotating means and the cleaning means are mounted for relative movement whereby the nozzle traverses longitudinally through the rotating air filter.

In use, a cylindrical air filter is positioned on the apparatus to rotate about its longitudinal axis. The cylindrical air filter is positioned in contact with the rotating means. The rotating means is connected to a motor in such a way that activation of the motor causes the rotating means to rotate. As the rotating means rotates, the cylindrical air filter is also caused to rotate about a longitudinal axis. On actuation of the apparatus the nozzle is caused to move relative to the cylindrical air filter. This may be achieved by, for instance, maintaining the lateral position of the rotating means and moving the nozzle along a longitudinal axis of the cylindrical air filter. The nozzle is connected to a gas source so that, as the nozzle and the air filter move relative to one another, gas is blown through the nozzle and then through the filter media, thereby blowing entrapped particulate matter free of the air filter.

When the apparatus is in use, rotation of the cylindrical air filter may be continuous. However, in an alternative embodiment of the invention, rotation of the cylindrical air filter may be carried out incrementally. In this embodiment, the air filter may be rotated only a fraction of a complete rotation and then held in place while the nozzle is moved relative to the air filter. Once completed, the air filter may be rotated another fraction of a complete rotation and the process repeated. The precise size of each incremental rotation is not critical, and may depend on the type of air filter being cleaned, and the type and quantity of particulate matter to be removed from the air filter.

Whilst the air filters described previously have been with respect to agricultural and mining applications, it should be understood that the apparatus of the present invention may be equally applied to cylindrical air filters used in any application. The particulate matter removed from the filter media through use of the apparatus may comprise dirt, rock or concrete dust in mining and construction applications, soot, or plant material such as pollen, leaves, grass or chaff in agricultural applications.

A variety of rotating means may be used, and the exact variety of rotating means used is not narrowly critical. However, for simplicity of construction and to provide good support for the cylindrical air filter, the rotating means comprises a pair of rollers that rotate about a longitudinal axis.

The pair of rollers may be of any suitable configuration such as, for instance, elongate cylinders. Advantageously, the pair of rollers consist of an elongate rod and a plurality of spaced-apart supports located along the length of the rod. The supports may be in the form of circular discs or cylinders that may be fabricated from any suitable material, such as plastic, rubber or ceramic. In use, the elongate rod passes through a longitudinal axis of the discs or cylinders, the discs or cylinders being held in fixed engagement with the elongate rod. Typically, the pair of rollers will be mounted substantially parallel to the longitudinal axis of the cylindrical air filter. In order to retain the pair of rollers in position, at least one end of the elongate member of each of the pair of rollers is mounted in a bearing.

In order to drive the rotating means, at least one of the rollers is connected to a drive unit. Typically, the drive unit is a motor, although other forms of drive unit may be used. The motor may be connected to the rotating means by any suitable method, such as a belt drive. The drive unit is powered by a power source in the form of a battery (and, in particular, a 12V battery), generator, a connection to mains power and the like.

As discussed previously, during use the nozzle is caused to move relative to the cylindrical air filter. This may be achieved by maintaining the air filter in place and moving the nozzle along a longitudinal axis of the air filter, or maintaining the nozzle in place and moving the air filter or a combination, so that the nozzle traverses longitudinally through the air filter. Alternatively, the nozzle may be adapted to rotate about a longitudinal axis of the air filter. In embodiments of the invention in which the nozzle may be adapted to rotate about a longitudinal axis of the air filter, the air filter may be maintained in a stationary position.

In the embodiment of the present invention wherein the air filter is maintained in place while the nozzle is moved to traverse through the air filter, the cleaning means of the apparatus may also include a path along which the nozzle travels. The path may comprise one of several different mechanisms, including a worm drive or a horizontal member having a channel along which the nozzle moves via a hydraulic strut. Alternatively, the nozzle may be fixed to a telescoping arm member that extends and retracts to achieve movement of the nozzle relative to the air filter.

If a horizontal member having a channel for movement of the nozzle is used, the movement of the nozzle along the channel may be achieved using a hydraulic strut. Typically, the range of movement of the nozzle along the channel will be restricted to the length of the air filter. The restriction may be achieved by any suitable means, although it is preferred that the restriction is achieved using limit sensors located in the channel to control the nozzle's movement. The locations of the limit sensors may be adjustable in order to change the range of movement of the nozzle, depending on the size of the cylindrical air filter being cleaned.

The nozzle may be connected to a source of gas, in order that the nozzle may blow a gas through the rotating air filter. The type of gas used is not narrowly critical, although flammable or toxic gases would generally be considered unsuitable. Typically, the source of gas will be an air compressor and the gas will be compressed air. The air compressor may also be used to drive the hydraulic strut or the telescoping arm member which moves the nozzle relative to the air filter. Persons skilled in the art will understand that the term “nozzle” may refer to a single nozzle or may refer to a nozzle arrangement comprising two or more nozzles.

In order to prevent unwanted lateral movement of the air filter when the apparatus is operational, it may be advantageous to provide the apparatus with one or more stops. In a preferred embodiment of the invention, the apparatus is provided with a pair of stops, the pair of stops located at opposed ends of the apparatus and defining the acceptable limits of lateral movement of an air filter when placed on the apparatus.

In some embodiments of the invention, the apparatus may be manually-operated. During manual operation, once the cylindrical air filter is positioned on the apparatus, the user may manually control the movement of the nozzle relative to the rotating air filter. Control of the movement of the nozzle relative to the air filter may be achieved using any suitable technique, such as, but not limited to, providing the apparatus with a control unit in communication with at least the cleaning means and having a user interface, the user interface having one or more controls in the form of buttons, levers and the like for actuating the movement of the cleaning means.

In an alternative embodiment of the invention, the apparatus may operate automatically. During automatic operation, the cylindrical air filter may be positioned on the apparatus, then the user may, for instance, make a selection from one or more pre-programmed automatic cleaning cycles. To achieve this, the apparatus may be provided with a control unit in communication with at least the cleaning means and having a user interface, the user interface having one or more controls in the form of buttons, levers and the like for selecting, starting and stopping one or more automatic cleaning cycles.

The apparatus may be encased in a housing in order to prevent particulates removed from the air filter from becoming airborne and posing a potential health and safety risk. The exact nature of the housing is not narrowly critical and may include any suitable housing, such as a cabinet, box, fume hood and the like. In some embodiments of the invention, the housing may be connected to a vacuum or similar dust extraction unit in order to remove particulates from the apparatus as they are blown free of the air filter.

### BRIEF DESCRIPTION OF THE DRAWINGS

An embodiment of the invention will be described with reference to the following drawings in which:

FIG. 1 illustrates an apparatus for removing particulates from a cylindrical air filter in accordance with an embodiment of the present invention.

FIG. 2 illustrates a view of a portion of an apparatus for removing particulates from a cylindrical air filter in accordance with an embodiment of the present invention.

FIG. 3 illustrates an end view of an apparatus for removing particulates from a cylindrical air filter in accordance with an embodiment of the present invention.

FIG. 4 illustrates an apparatus for removing particulates from a cylindrical air filter in accordance with an embodiment of the present invention.

FIG. 5 illustrates the control unit of an apparatus for removing particulates from a cylindrical air filter in accordance with an embodiment of the present invention.

### DETAILED DESCRIPTION OF THE PREFERRED EMBODIMENTS

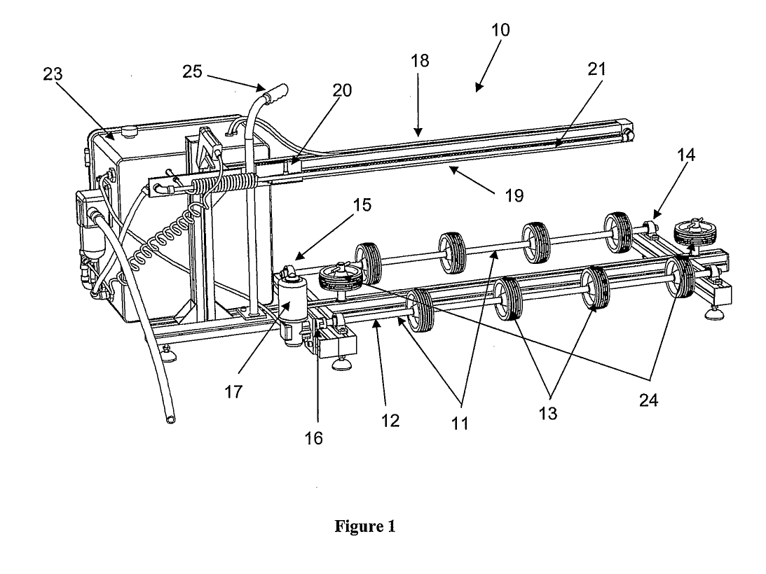

FIG. 1 illustrates an apparatus for removing particulates from a cylindrical air filter in accordance with an embodiment of the present invention. The apparatus 10 comprises rotating means in the form of a pair of rollers 11. The pair of rollers 11 consist of an elongate member 12 and a series of spaced apart discs 13. Opposed ends of the elongate member 12 are mounted in a bearings 14, 15 to prevent lateral movement and ensure smooth rotation of the pair of rollers 11.

To create the rotation of the pair of rollers 11 in the embodiment of the invention illustrated in FIG. 1, one roller of the pair of rollers 11 is connected via a coupling 16 to a motor 17. Actuation of the motor 17 drives rotation of the one roller of the pair of rollers 11. Rotation of the second roller of the pair of rollers 11 occurs when a cylindrical air filter (not shown) is placed in position resting on the spaced apart discs 13 of the pair of rollers 11.

The apparatus 10 further comprises cleaning means 18 comprising a horizontal member 19. The apparatus is provided with a nozzle assembly 20 comprising, in this embodiment of the invention, three nozzles. Upon actuation, the nozzle assembly 20 moves along a nozzle path 21 on the side of the horizontal member 19. The nozzle path 21 may be provided with limit sensors (not shown) at each end to limit the horizontal movement of the nozzle within the channel 20. While the nozzle assembly 20 of the embodiment of the invention of FIG. 1 is illustrated pointing vertically upwards, the exact orientation of the nozzle assembly 20 is not narrowly critical, and the nozzle assembly may be oriented in any direction.

In use, a cylindrical air filter (not shown) is placed horizontally on the pair of rollers 11 with the horizontal member 19 passing longitudinally through the air filter. As the air filter rotates, the nozzle assembly 20 travels along the nozzle path 21, blowing gas through the air filter, thus removing particulate matter from the air filter. The movement of the nozzle assembly 20 is controlled by the control unit 23.

The apparatus 10 is further provided with a pair of stops 24. In use, opposed ends of the cylindrical air filter (not shown) rest adjacent the pair of stops 24. Thus, the pair of stops 24 prevents unwanted lateral movement of the air filter during its rotation.

The apparatus 10 is further provided with a handle 25 to simplify the transportation and placement of the apparatus 10.

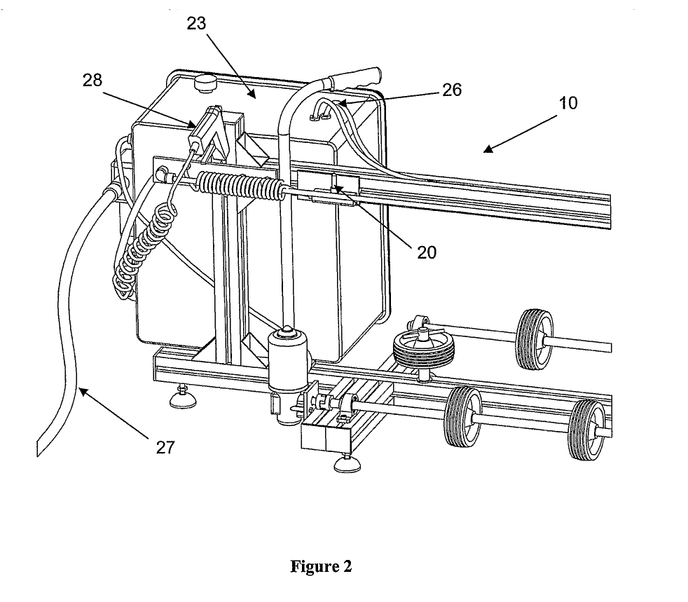

FIG. 2 illustrates one end of the apparatus 10. The control unit 23 is connected to the nozzle assembly 20 by way of compressed air lines 26. Compressed air may be used for pneumatic actuation of the nozzle assembly 20. Compressed air may be supplied from an air compressor (not shown) through an air line 27 connected to the control unit 23. The apparatus 10 may also be supplied with a hand-operated compressed air gun 28 to enable further manual cleaning of the air filter (not shown) or for cleaning up any dust in the vicinity of the apparatus 10.

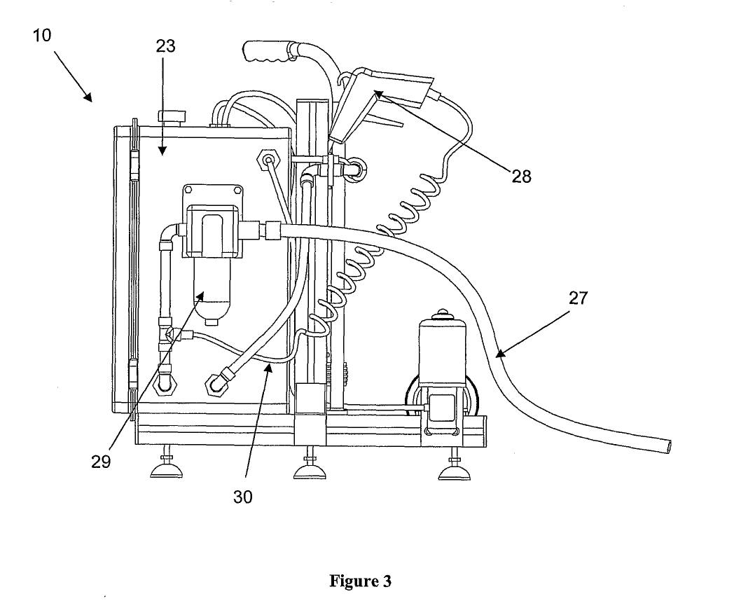

FIG. 3 illustrates an end view of the apparatus 10. The air line 27 from the air compressor (not shown) is connected to a water trap 29 before entering the control unit 23. A bleed line 30 is used to provide air to the compressed air gun 28.

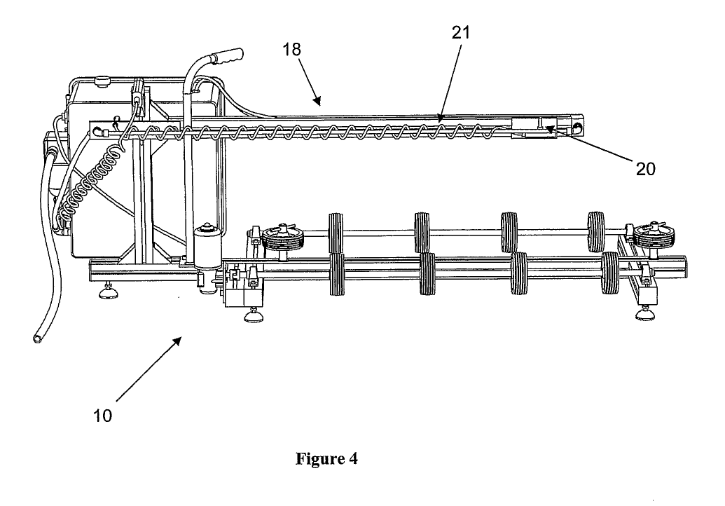

FIG. 4 shows the apparatus 10 of the present invention in which the nozzle assembly 20 has been actuated and has moved along the nozzle path 21 to the far end of the horizontal member 18.

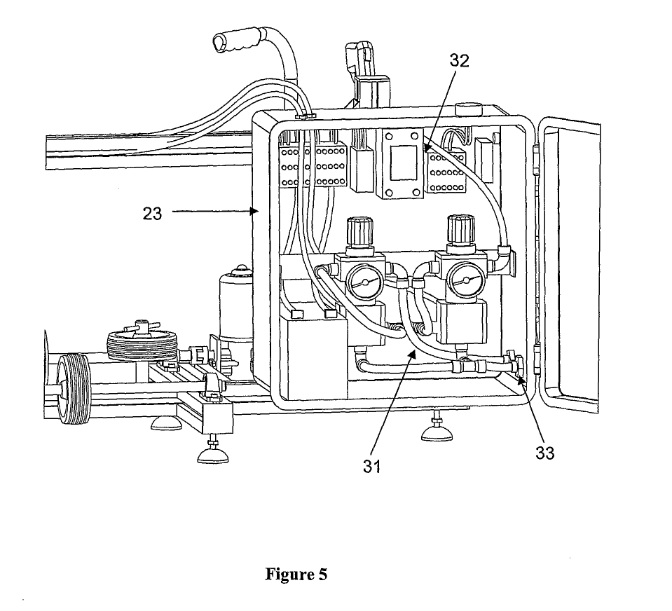

FIG. 5 shows the internal working of the control unit 23. The control unit 23 is essentially divided into two sections: a pneumatic section 31 for control of the movement of the nozzle assembly (not shown) and an electrical section 32 for controlling the operation of the motor (not shown). The pneumatic section is supplied with compressed air from an air compressor (not shown). The compressed air enters the pneumatic section through an air inlet point 33 in the wall of the control unit 23. In the embodiment of the invention illustrated in FIG. 5, the electrical section 32 is supplied with electricity from an external power source (not shown).

Those skilled in the art will appreciate that the present invention may be susceptible to variations and modifications other than those specifically described. It will be understood that the present invention encompasses all such variations and modifications that fall within its spirit and scope.

1. An apparatus for removing particulates from a cylindrical air filter, said apparatus comprising:
a rotating means for rotating the air filter about a longitudinal axis; and
a cleaning means comprising a nozzle adapted to blow a gas through said air filter to remove particulates from the air filter,
wherein the rotating means and the cleaning means are mounted for relative movement whereby the nozzle traverses longitudinally through the rotating air filter, and wherein the air filter is both mounted to the apparatus and cleaned in a substantially horizontal orientation.

2. An apparatus for removing particulates from a cylindrical air filter according to claim 1, wherein the cleaning means is adapted for movement relative to the rotating means.

3. An apparatus for removing particulates from a cylindrical air filter according to claim 1, wherein the apparatus further comprises means for preventing the lateral movement of the air filter during use.

4. An apparatus for removing particulates from a cylindrical air filter according to claim 1, wherein the rotating means comprises two or more rollers.

5. An apparatus for removing particulates from a cylindrical air filter according to claim 1, wherein the rotation of the air filter on the rotating means may be continuous, incremental, or a combination thereof.

6. An apparatus for removing particulates from a cylindrical air filter according to claim 1, wherein the gas blown through the nozzle is compressed air.

7. An apparatus for removing particles from a cylindrical air filter according to claim 1, wherein the cleaning means comprises one or more nozzles.

8. An apparatus for removing particles from a cylindrical air filter according to claim 1, wherein the cleaning means is adapted to rotate about a longitudinal axis of the air filter.

9. An apparatus for removing particles from a cylindrical air filter according to claim 8, the air filter is retained in a stationary position while the cleaning means rotates about the longitudinal axis of the air filter.

10. An apparatus for removing particulates from a cylindrical air filter according to claim 1, wherein the apparatus is adapted to be housed within a housing.

11. An apparatus for removing particulates from a cylindrical air filter according to claim 10, the housing is provided with means for extracting the removed particulates.
